(19) United States
(12) Patent Application Publication
(10) Pub. No.: US 2015/0025711 A1
(43) Pub. Date: Jan. 22, 2015

(54) METHOD OF SHARING SET DATA FOR VEHICLE CONTROL

(71) Applicants: Hyundai Motor Company, Seoul (KR); Kia Motors Corporation, Seoul (KR); Hyundai AutoEver Corp., Seoul (KR)

(72) Inventors: Sun Woo KWON, Seoul (KR); Tae Won KIM, Seoul (KR); Seung Uk YUN, Seoul (KR)

(21) Appl. No.: 14/333,086

(22) Filed: Jul. 16, 2014

(30) Foreign Application Priority Data
Jul. 17, 2013 (KR) 10-2013-0084068

(51) Int. Cl. G05D 1/00

(52) U.S. Cl. CPC G05D 1/0016; G05D 1/0022
USPC 701/2

(57) ABSTRACT

A method of sharing set data for a vehicle control includes reflecting requirements of a user and generating the set data for the vehicle control by a smartphone. The set data for the vehicle control is transmitted to a vehicle mounted terminal according to a request of the user. The set data for the vehicle control is received through a network by the vehicle mounted terminal. Instructions are set according to a condition based on the received set data for the vehicle control by the vehicle mounted terminal.

### CROSS-REFERENCE TO RELATED APPLICATION

This application is based on and claims the benefit of priority to Korean Patent Application No. 10-2013-0084068, filed on Jul. 17, 2013 in the Korean Intellectual Property Office, the disclosure of which is incorporated herein in its entirety by reference.

### TECHNICAL FIELD

The present disclosure relates to a method of sharing set data for a vehicle control, and more particularly, to a technology capable of sharing set data for a vehicle control including conditional information and execution instructions corresponding to the conditional information between vehicle mounted terminals in various methods.

### BACKGROUND

In general, a method of controlling various devices (a device for convenience, audible device, a brake device) in a vehicle include a method of directly controlling the devices by a driver, a method of inputting set information by the driver, a method of remotely controlling the devices by the driver, etc.

In recent, as the number of various devices mounted in the vehicle is exponentially increased, it is difficult to efficiently use the devices for the driver.

Therefore, a method has been demanded, which is capable of directly sharing set data including conditional information and execution instructions corresponding to the conditional information between vehicle mounted terminals by various methods, that is, a mobile instant messenger (MIM) such as Kakao Talk, a social network service (SNS) such as facebook, or the like.

According to the related art, a concept for the set data including the execution instructions corresponding to the conditional information has not been established and a message transmitted through the MIN or the SNS just includes a text, a picture, a video, or the like, and had not transmitted set data for a vehicle control.

### SUMMARY

The present disclosure has been made to solve the above-mentioned problems occurring in the prior art while advantages achieved by the prior art are maintained intact.

An aspect of the present disclosure provides a method of sharing set data for a vehicle control capable of efficiently using various devices mounted in a vehicle by enabling the set data for the vehicle control including conditional information and execution instructions corresponding to the conditional information to share between vehicle mounted terminals in various methods.

According to an exemplary embodiment of the present disclosure, a method of sharing set data for a vehicle control includes reflecting requirements of a user and generating the set data for the vehicle control by a smartphone. The set data for the vehicle control is transmitted to a vehicle mounted terminal according to a request of the user. The set data for the vehicle control is received through a network by the vehicle mounted terminal. Instructions are set according to a condition based on the received set data for the vehicle control by the vehicle mounted terminal.

According to another exemplary of the present disclosure, a method of sharing set data for a vehicle control includes reflecting requirements of a user and generating the set data for the vehicle control by a smartphone. The set data for the vehicle control and corresponding application data is transmitted to a vehicle mounted terminal according to a request of the user. The set data for the vehicle control and the corresponding application data is received through a network by the vehicle mounted terminal. The received application data is installed by the vehicle mounted terminal. Instructions are set according to a condition based on the received set data for the vehicle control by the vehicle mounted terminal.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of a system of sharing set data for a vehicle control according to an exemplary embodiment of the present disclosure.

FIG. 2 is a flow chart of a method of sharing set data for a vehicle control according to an exemplary embodiment of the present disclosure.

FIG. 3 is a flow chart of a method of sharing set data for a vehicle control according to another exemplary embodiment of the present disclosure.

### DETAILED DESCRIPTION

Hereinafter, exemplary embodiments of the present disclosure will be described in detail with reference to the accompanying drawings.

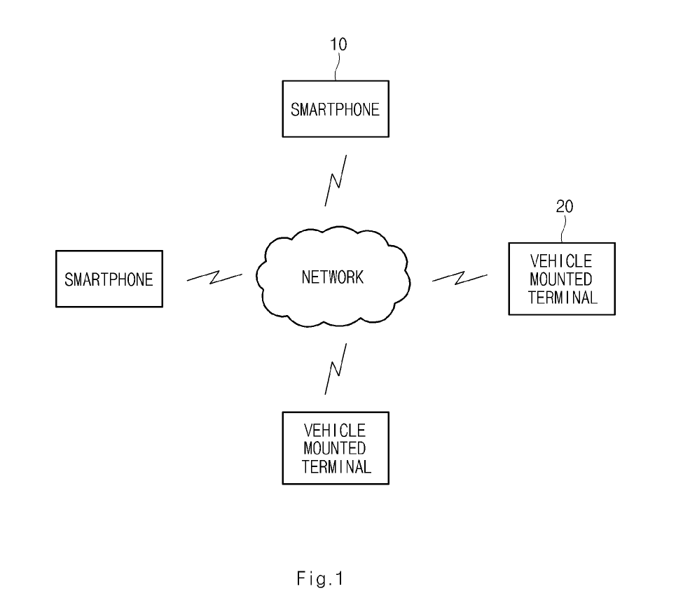

FIG. 1 is a configuration diagram of a system of sharing set data for a vehicle control according to an exemplary embodiment of the present disclosure. As shown in FIG. 1, a system of sharing set data for a vehicle control according to an exemplary embodiment of the present disclosure may include one or more smartphones 10 connected to each other through a network and one or more vehicle mounted terminals 20.

Describing the respective components, the smartphone 10 may provide a user interface, and particularly, may provide an environment capable of generating, changing, deleting, and transmitting the set data for the vehicle control to a user.

Here, the set data is package data including conditional information and execution instructions corresponding to the conditional information.

For example, the set data including the conditional data ‘a residue amount of fuel is a threshold value or less’ and the execution instruction ‘display a fueling station (e.g., a filling station, a gas station, an electricity charging point, or the like) within a set distance from a current position’ may be generated. In this case, displayed information is changed depending on a kind of fuel. That is, when the fuel is gasoline, the fueling station becomes the filling station, and when the fuel is gas, the fueling station becomes the gas station.

As another example, the set data including the conditional information ‘a room temperature of the vehicle exceeds a threshold value’ and the execution instruction ‘operate an air conditioner until the room temperature of the vehicle becomes a reference value or less’ may be generated.

The set data generated as described above is transmitted to other smartphones as well as the respective vehicle mounted terminals 20 through the network (wireline/wireless Internet, mobile communications, local area network, or the like)

Next, the vehicle mounted terminal 20, which is an audio, video, navigation (AVN) device having a web browser installed therein, as an example, sets instructions according to the corresponding condition when it receives the set data for the vehicle control from other vehicle mounted terminals or the smartphones through the network. That is, the vehicle mounted terminal 20 sets the instructions according to the corresponding condition based on the set data for the vehicle control.

As an example, the vehicle mounted terminal 20 in which the instructions according to the condition is set may monitor the residue amount of fuel and may display the fueling station closest to the current position on a screen when the residue amount of fuel becomes the threshold value or less.

As another example, the vehicle mounted terminal 20 in which the instruction according to the condition is set may monitor the room temperature of the vehicle and may operate the air conditioner until the room temperature of the vehicle becomes the threshold or less when the room temperature of the vehicle exceeds the threshold value.

When an application for processing the set data for the vehicle control received from the outside is not installed in the vehicle mounted terminal 20, the vehicle mounted terminal may be connected to an uniform resource locator (URL) included in the set data for the vehicle control to download and install the corresponding application and to then set the instruction according to the condition based on the set data for the vehicle control.

As another method, when the smartphone 10 transmits the set data for the vehicle control to the other smartphones or vehicle mounted terminals, it may simultaneously transmit an application for processing the set data for vehicle control. This is similarly applied to a case in which the vehicle mounted terminal 20 transmits the set data for the vehicle control to the smartphone or the other vehicle mounted terminals.

Further, the vehicle mounted terminal 20 having the web browser installed therein may provide the user interface, and particularly, may provide an environment capable of generating, changing, deleting, and transmitting the set data for the vehicle control to the user.

The smartphone 10 and the vehicle mounted terminal 20 described above may use the MIM such as Kakao talk, or the like or the SNS such as the facebook for transmitting the set data of the vehicle control.

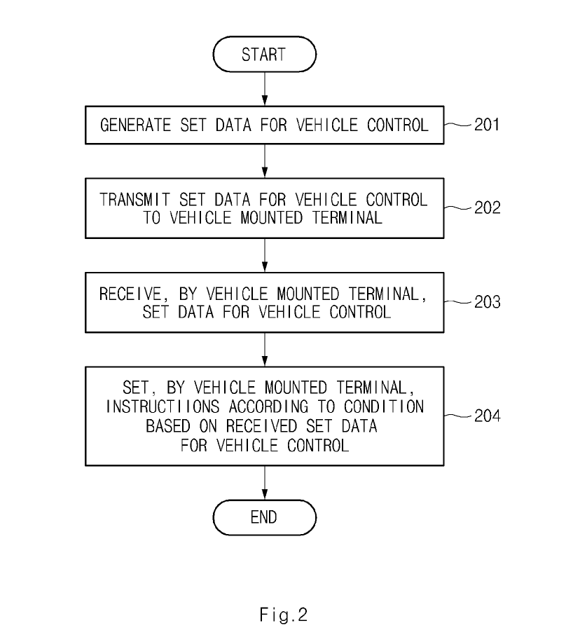

FIG. 2 is a flow chart of a method of sharing set data for a vehicle control according to an exemplary embodiment of the present disclosure.

First, the smartphone 10 reflects requirements of a user and generates set data for vehicle control (201). In this case, the smartphone 10 provides a graphic environment capable of the set data for the vehicle control to the user.

The smartphone 10 then transmits the generated set data for the vehicle control to the vehicle mounted terminal 20 according to a request of the user (202).

The vehicle mounted terminal 20 receives the set data for the vehicle control from other vehicle mounted terminals 20 or the smartphone 10 through the network (203). In this case, the vehicle mounted terminal 20 may receive the set data for the vehicle control through a variety of messengers, e-mail, social network, or the like.

Next, the vehicle mounted terminal 20 sets instructions according to the condition based on the received set data for the vehicle control (204). In this case, when an application for processing the received set data for the vehicle control is not installed in the vehicle mounted terminal 20, the vehicle mounted terminal 20 may be connected to an uniform resource locator (URL) included in the set data for the vehicle control to download and install the corresponding application.

A process of installing the application may be automatically performed and may be performed by obtaining permission of the user.

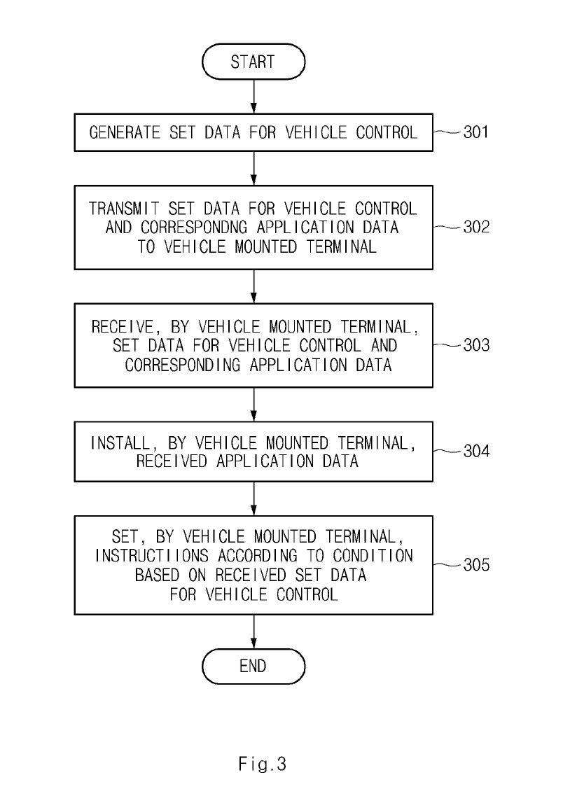

FIG. 3 is a flow chart of a method of sharing set data for a vehicle control according to another exemplary embodiment of the present disclosure.

First, the smartphone 10 reflects requirements of the user and generates the set data for the vehicle control (301). In this case, the smartphone 10 provides a graphic environment capable of the set data for the vehicle control to the user.

The smartphone 10 transmits the generated set data for the vehicle control and corresponding application data to the vehicle mounted terminal 20 according to a request of the user (302).

The vehicle mounted terminal 20 receives the set data for the vehicle control and the corresponding application data from other vehicle mounted terminals 20 or the smartphone 10 through the network. In this case, the vehicle mounted terminal 20 may receive the set data for the vehicle control through a variety of messengers, e-mail, social network, or the like.

The vehicle mounted terminal 20 installs the received application (304). In this case, if the application is pre-installed in the vehicle mounted terminal 20, a process of installing the application is not performed.

Next, the vehicle mounted terminal 20 sets instructions according to the condition based on the received set data for the vehicle control (305).

Although an exemplary embodiment of the present disclosure describes the case in which the smartphone 10 generates the set data for the vehicle control and then transmits it to the vehicle mounted terminal 20, as an example, the other vehicle mounted terminals may generate the set data for the vehicle control and then transmit it to the vehicle mounted terminal 20.

Although an exemplary embodiment of the present disclosure describes the sharing of set data for the vehicle control, the present disclosure may be applied to the vehicle control as well as a home automated system.

According to the exemplary embodiments of the present disclosure, various devices mounted in a vehicle may be efficiently used by enabling the set data for the vehicle control including conditional information and execution instructions corresponding to the conditional information to share between the vehicle mounted terminals in various methods.

What is claimed is:

1. A method of sharing set data for a vehicle control, the method comprising steps of:
reflecting, by a smartphone, requirements of a user and generating the set data for the vehicle control;
transmitting the set data for the vehicle control to a vehicle mounted terminal according to a request of the user;
receiving, by the vehicle mounted terminal, the set data for the vehicle control through a network; and
setting, by the vehicle mounted terminal, instructions according to a condition based on the received set data for the vehicle control.

2. The method according to claim 1, wherein the set data for the vehicle control is package data including conditional information and execution instructions corresponding to the conditional information.

3. The method according to claim 1, wherein the step of setting the instructions includes connecting the vehicle mounted terminal to an uniform resource locator (URL) included in the set data for the vehicle control to download and install a corresponding application when an application for installing the set data for the vehicle control is not installed in the vehicle mounted terminal.

4. A method of sharing set data for a vehicle control, the method comprising steps of:
reflecting, by a smartphone, requirements of a user and generating the set data for the vehicle control;
transmitting the set data for the vehicle control and corresponding application data to a vehicle mounted terminal according to a request of the user;
receiving, by the vehicle mounted terminal, the set data for the vehicle control and the corresponding application data through a network;
installing, by the vehicle mounted terminal, the received application data; and
setting, by the vehicle mounted terminal, instructions according to a condition based on the received set data for the vehicle control.

5. The method according to claim 4, wherein the set data for the vehicle control is package data including conditional information and execution instructions corresponding to the conditional information.
